(19) United States
(12) Patent Application Publication
(10) Pub. No.: US 2015/0360500 A1
(43) Pub. Date: Dec. 17, 2015

(54) Security Device with Covert Images

(71) Applicant: INNOVIA SECURITY PTY LTD, Craigieburn, Victoria (AU)

(72) Inventor: Phei Lok, Victoria (AU)

(73) Assignee: Innovia Security Pty Ltd, Craigieburn, Victoria (AU)

(21) Appl. No.: 14/768,348

(22) PCT Filed: Feb. 13, 2014
(86) PCT No.: PCT/AU2014/000118

§ 371 Date: Aug. 17, 2015

(30) Foreign Application Priority Data
Feb. 19, 2013 (AU) 2013100172
Feb. 19, 2013 (AU) 2013900534

(51) Int. Cl. B42D 25/30; G02B 5/30

(52) U.S. Cl. CPC B42D 25/30; G02B 5/3016

(57) ABSTRACT

A security device comprises a transparent substrate having an opacifying layer disposed on at least one surface. A reflective grating layer comprises one or more arrangements of grooves, and a liquid crystal material layer is disposed over at least a portion of the grating layer. The arrangements of grooves have a groove spacing such that liquid crystal molecules within the liquid crystal material layer are substantially aligned so as to polarise optical radiation passing therethrough. The security device further includes apertures formed in the opacifying layer and the grating layer comprising a transmissive diffractive optical element (DOE). The security device thereby comprises a transmissive security feature, visible when viewed in transmission mode by the naked eye, in combination with a covert, reflective security feature, visible only using a suitably oriented polariser.

### FIELD OF THE INVENTION

The present invention relates to security devices for security documents, tokens or similar articles, and in particular to such articles comprising a combination of transmissive and reflective covert security devices and features, and methods for their manufacture.

### BACKGROUND TO THE INVENTION

It is known to apply diffraction gratings and similar optically detectable microstructures to security documents or similar articles, such as identity cards, passports, credit cards, bank notes, cheques and the like. Such microstructures have the advantages of being difficult to falsify or modify, and being easily destroyed or damaged by any attempts made to tamper with the document. Furthermore, they can be designed and fabricated as overt features of the document, such that they are visible with the naked eye, without the use of any additional viewing apparatus, thus enabling members of the public to perform some degree of authentication of the document. Accordingly, such optically detectable structures may be used to provide an effective security feature.

Nevertheless, over recent years counterfeiting groups have become better organised and more technically competent. As a result, attempts at simulation of genuine security elements have become increasingly successful. As noted above, it is a common feature of optical security elements suitable for authentication by members of the public that the images are visible by directly viewing the security element. Typical members of the public are inexpert in detecting small variations in the optical effects produced by diffraction gratings. Thus, although it is difficult for a counterfeiter to reproduce the exact optical effect of the security element, it is easily possible to create a passable forgery that may appear sufficiently similar to the optical effect to the casual observer.

Improved authentication can be achieved by including more security features in a document, including covert features which are not visible with the naked eye, and which require additional apparatus to reveal their presence and appearance and including new and improved versions of these features. For example, it is known to use liquid crystals to produce security documents including hidden images which only become visible when viewed through a suitably-oriented polariser (i.e. polarising filter). The disadvantage of such features is that they can only be authenticated by an observer with the appropriate viewing apparatus.

It is therefore desirable to provide improved security documents, tokens or similar articles including alternative secondary features for authentication. The first feature provide a first level of security which is available in the absence of additional viewing apparatus, while the second feature provide an additional level of security which enable the document to be authenticated more reliably if the necessary additional viewing apparatus is available.

### DEFINITIONS

### Security Document or Token

As used herein the term security documents and tokens includes all types of documents and tokens of value and identification documents including, but not limited to the following: items of currency such as banknotes and coins, credit cards, cheques, passports, identity cards, securities and share certificates, driver's licenses, deeds of title, travel documents such as airline and train tickets, entrance cards and tickets, birth, death and marriage certificates, and academic transcripts.

The invention is particularly, but not exclusively, applicable to security documents or tokens such as banknotes or identification documents such as identity cards or passports formed from a substrate to which one or more layers of printing are applied. The diffraction gratings and optically variable elements described herein may also have application in other products, such as packaging.

### Substrate

As used herein, the term substrate refers to the base material from which the security document or token is formed. The base material may be paper or other fibrous material such as cellulose; a plastic or polymeric material including but not limited to polypropylene (PP), polyethylene (PE), polycarbonate (PC), polyvinyl chloride (PVC), polyethylene terephthalate (PET); or a composite material of two or more materials, such as a laminate of paper and at least one plastic material, or of two or more polymeric materials.

### Opacifying Layers

One or more opacifying layers may be applied to a transparent substrate to increase the opacity of the security document. An opacifying layer is such that L_{T}<L₀, where L₀ is the amount of light incident on the document, and L_{T} is the amount of light transmitted through the document. An opacifying layer may comprise any one or more of a variety of opacifying coatings. For example, the opacifying coatings may comprise a pigment, such as titanium dioxide, dispersed within a binder or carrier of heat-activated cross-linkable polymeric material. Alternatively, a substrate of transparent plastic material could be sandwiched between opacifying layers of paper or other partially or substantially opaque material to which indicia may be subsequently printed or otherwise applied.

### Diffractive Optical Elements (DOEs)

As used herein, the term diffractive optical element refers to a numerical-type diffractive optical element (DOE). Numerical-type diffractive optical elements (DOEs) rely on the mapping of complex data that reconstruct in the far field (or reconstruction plane) a two-dimensional intensity pattern. Thus, when substantially collimated light, e.g. from a point light source or a laser, is incident upon the DOE, an interference pattern is generated that produces a projected image in the reconstruction plane that is visible when a suitable viewing surface is located in the reconstruction plane, or when the DOE is viewed in transmission at the reconstruction plane. The transformation between the two planes can be approximated by a fast Fourier transform (FFT). Thus, complex data including amplitude and phase information has to be physically encoded in the micro-structure of the DOE. This DOE data can be calculated by performing an inverse FFT transformation of the desired reconstruction (i.e. the desired intensity pattern in the far field).

DOEs are sometimes referred to as computer-generated holograms, but they differ from other types of holograms, such as rainbow holograms, Fresnel holograms and volume reflection holograms.

### Embossable Radiation Curable Ink

The term embossable radiation curable ink used herein refers to any ink, lacquer or other coating which may be applied to the substrate in a printing process, and which can be embossed while soft to form a relief structure and cured by radiation to fix the embossed relief structure. The curing process does not take place before the radiation curable ink is embossed, but it is possible for the curing process to take place either after embossing or at substantially the same time as the embossing step. The radiation curable ink is preferably curable by ultraviolet (UV) radiation. Alternatively, the radiation curable ink may be cured by other forms of radiation, such as electron beams or X-rays.

The radiation curable ink is preferably a transparent or translucent ink formed from a clear resin material. Such a transparent or translucent ink is particularly suitable for printing light-transmissive security elements such as sub-wavelength gratings, transmissive diffractive gratings and lens structures. One or more pigments may be used to create partially or fully opaque embossable inks. Metallic particles may be added to create reflective relief structures.

A transparent or translucent ink may comprise an acrylic based UV curable clear embossable lacquer or coating. Such UV curable lacquers can be obtained from various manufacturers, including Kingfisher Ink Limited, product ultraviolet type UVF-203 or similar. Alternatively, the radiation curable embossable coatings may be based on other compounds, eg nitro-cellulose.

The radiation curable inks and lacquers used herein have been found to be particularly suitable for embossing microstructures, including diffractive structures such as diffraction gratings and holograms, and microlenses and lens arrays.

With some polymeric substrates, it may be necessary to apply an intermediate layer to the substrate before the radiation curable ink is applied to improve the adhesion of the embossed structure formed by the ink to the substrate. The intermediate layer preferably comprises a primer layer, and more preferably the primer layer includes a polyethylene imine. The primer layer may also include a cross-linker, for example a multi-functional isocyanate. Examples of other primers suitable for use in the invention include: hydroxyl terminated polymers; hydroxyl terminated polyester based co-polymers; cross-linked or uncross-linked hydroxylated acrylates; polyurethanes; and UV curing anionic or cationic acrylates. Examples of suitable cross-linkers include: isocyanates; polyaziridines; zirconium complexes; aluminium acetylacetone; melamines; and carbodi-imides.

### SUMMARY OF THE INVENTION

In one aspect, the invention provides a security device comprising:

a transparent substrate;

an opacifying layer;

a reflective grating layer comprising one or more arrangements of grooves; and

a liquid crystal material layer disposed over at least a portion of the grating layer,

wherein the arrangements of grooves have a groove spacing such that liquid crystal molecules within the liquid crystal material layer are substantially aligned so as to polarise optical radiation passing therethrough, and

wherein the security device further includes apertures formed in the opacifying layer and the grating layer, the apertures comprising a transmissive diffractive optical element (DOE).

Advantageously, a security device embodying the invention comprises a covert security feature, in the form of a pattern of reflected light which is made visible by viewing through a polariser along with another covert security feature, in the form of the transmissive DOE. DOEs are, generally, considered in the industry to be a covert or a semi-covert feature, as a point light source is required to authenticate the feature and, therefore, the projected image, which provides verification, is not visible under normal conditions.

In some embodiments, the grating layer is formed in a surface of the opacifying layer.

Alternatively, the grating layer may be formed in an embossable material layer of the security device. The embossable material layer may be disposed on a surface of the opacifying layer. Alternatively, the opacifying layer may be disposed on a first surface of the substrate and the embossable material layer may be disposed on a second surface of the substrate, opposite to the first surface.

In some embodiments, the apertures are further formed in the liquid crystal material layer, aligned with the apertures in the opacifying layer and the grating layer. Advantageously, this enables light to pass through the apertures, in order to form an image in a reconstruction plane, without attenuation, scattering or diffusion occurring due to the presence of liquid crystal material within the apertures.

In some embodiments of the invention, the one or more arrangements of grooves comprise regions of grooves having a first orientation configured such that a first image is visible when the security device is viewed through a polariser having a corresponding first orientation. The one or more arrangements of grooves may further comprise regions of grooves having a second orientation configured such that a second image is visible when the security device is viewed through a polariser having a corresponding second orientation. Further orientations and configurations of regions of grooves may be formed so as to enable additional images to be visible using polarisers having different orientations.

In some embodiments, the arrangements of grooves in the grating layer comprise gratings having a zero order characteristic within a predetermined viewing range of optical frequencies. In particular, the gratings may have a period of between 100 nm and 1 μm. In some embodiments, the gratings have a period of between 100 nm and 300 nm.

In another aspect, the present invention provides a method of producing a security device comprising:

providing a transparent substrate;

applying an opacifying layer to a surface of the transparent substrate to form an opacified substrate;

forming a reflective grating layer on a surface of the opacified substrate;

applying a liquid crystal material layer to the surface of the opacified substrate on which the grating layer is formed, and curing the liquid crystal material layer; and

ablating apertures in the opacifying layer and the grating layer to form a transmissive diffractive optical element (DOE) in the security device,

wherein the reflective grating layer comprises one or more arrangements of grooves having a groove spacing such that liquid crystal molecules within the liquid crystal material layer are substantially aligned so as to polarise optical radiation passing therethrough.

In some embodiments, the step of forming a reflective grating layer includes forming the reflective grating layer in a surface of the opacifying layer.

Alternatively, the step of forming a reflective grating layer may comprise applying an embossable material layer to the opacified substrate, and embossing the one or more arrangements of grooves into a surface of the embossable material layer. In some embodiments, applying the embossable material layer comprises applying the embossable material layer to a surface of the opacifying layer. Alternatively, applying the embossable material layer may comprise applying the embossable material layer to a surface of the opacified substrate opposite to the surface on which the opacifying layer is disposed.

In a preferred embodiment, the apertures are formed by ablation, preferably by laser ablation. In some embodiments, the step of ablating apertures in the opacifying layer and the grating layer is performed prior to applying the liquid crystal material layer. In other embodiments, the step of ablating apertures is performed after applying the liquid crystal material layer, such that apertures are further formed in the liquid crystal material layer, aligned with the apertures in the opacifying layer and the grating layer.

According to further aspects of the invention, there are provided security documents comprising security devices in accordance with the first aspect of the invention, and/or such as may be produced in accordance with methods embodying the second aspect of the invention. Security documents in accordance with this aspect of the invention may comprise banknotes.

Further aspects, features and advantages of the invention will be apparent from the following description of particular embodiments, which is provided by way of example only, and should not be considered limiting of the scope of the invention as defined in any of the preceding statements, or in the claims appended hereto.

### BRIEF DESCRIPTION OF THE DRAWINGS

Embodiments of the invention will now be described with reference to the accompanying drawings, in which like reference numerals refer to like features, and wherein:

FIG. 1 is a schematic diagram illustrating steps involved in a method of producing a DOE with covert images according to an embodiment of the invention;

FIG. 2 is a schematic diagram illustrating viewing an image generated from a DOE in a reconstruction plane, according to an embodiment of the invention;

FIG. 3 is a schematic diagram illustrating viewing of a covert image via a polariser, according to an embodiment of the invention;

FIG. 4 illustrates schematically a second embodiment of a security document including a security device embodying the invention;

FIG. 5 illustrates schematically a third embodiment of a security document including a security device embodying the invention;

FIG. 6 illustrates a fourth embodiment of a security document including a security device embodying the invention;

FIG. 7 is a schematic diagram illustrating combined projected and covert images in a security device embodying the invention;

FIG. 8(a) illustrates schematically the covert image of FIG. 7 as viewed through a polariser having a first orientation; and

FIG. 8(b) illustrates schematically the covert image of FIG. 7 as viewed through a polariser having a second orientation.

### DESCRIPTION OF EMBODIMENTS

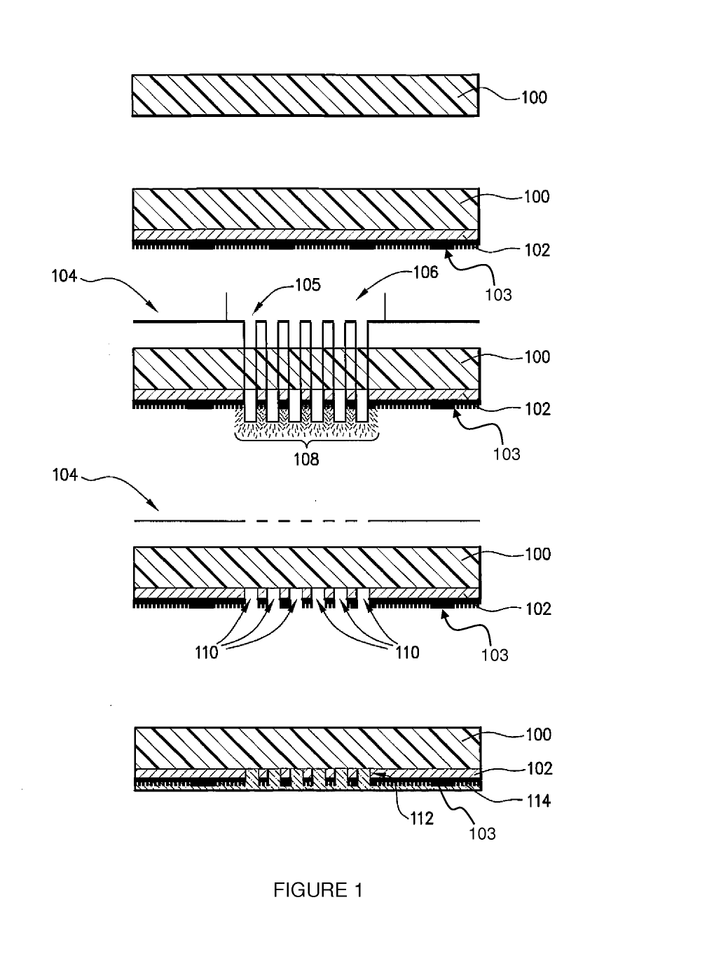

FIG. 1 shows schematically a transparent substrate 100, such as a plastics film formed from polymeric material, used in the manufacture of a security document, token, or similar article. The substrate 100 may be made from at least one biaxially-oriented polymeric film. The substrate 100 may include or consist of a single layer of film of polymeric material or, alternatively, a laminate of two or more layers of transparent polymeric film. The substrate 100 is shown in cross-section in FIG. 1.

According to the illustrated embodiment, an opacifying layer 102 is applied to one surface of the substrate 100.

A grating layer 103 is disposed on the opacifying layer 102. The grating layer 103 comprises one or more arrangements of grooves formed in a layer of suitable engravable or embossable material. Each arrangement of grooves preferably consists of a linear repeating pattern, i.e. a grating, forming uniformly spaced features of similar cross-section. The cross-section of the grooves may be, for example, substantially rectangular, however any appropriate cross-section suitable for aligning liquid crystals (as described in greater detail below) may be used.

According to embodiments of the invention, the gratings formed in the grating layer 103 are of zero-order over wavelengths of interest, and in these embodiments it is a requirement that the grating period be less than half the wavelength of light at the frequencies of interest. As such, for applications ranging from the near-infrared, through the visible spectrum, into the near-ultraviolet, it is preferred that the grating period is between 100 nm and 1 μm, and more preferably between 100 nm and 300 nm.

Furthermore, according to embodiments of the invention the material from which the grating layer 103 is formed contains metallic particles such that the layer is reflective at the intended frequencies of use, e.g. between the near-infrared and the near-ultraviolet. Furthermore, the material from which the grating layer 103 is formed may include other pigments or dyes in order to absorb radiation at selected wavelengths, such that substantially only unabsorbed wavelengths of radiation are reflected from the grating layer.

The grating layer 103 may be manufactured, according to some embodiments of the invention, as follows. Firstly, a suitable material, such as a layer of embossable radiation-curable ink, is disposed on the surface of the opacifying layer 102. The desired arrangement of grooves is then formed in this layer using an embossing device. The embossing device (not shown) includes an arrangement of embossing elements comprising protrusions corresponding with the desired arrangement of grooves within the grating layer 103. The surface of the embossing device comprising the protrusions is pressed into the embossable layer, which is simultaneously and/or subsequently cured to fix the grooves in the surface.

An amplitude DOE 112 is then formed by ablating apertures in the layers 102, 103, which allows light to pass through in order to generate a DOE-projected image. One method of forming the amplitude DOE is illustrated in FIG. 1, employing a mask 104 having apertures 105 formed therein. The apertures 105 are illuminated with laser radiation 106, thereby forming a patterned laser beam 108 corresponding with the desired diffractive structure of the amplitude DOE, in accordance with the mask 104.

As shown in FIG. 1, the patterned laser beam 108 has a wavelength selected such that the light passes through the transparent substrate 100 and irradiates the opacifying layer 102. The laser radiation 108 is absorbed in the opacifying layer 102 and the grating layer 103, resulting in ablation of these coatings and the formation of apertures 110. The apertures 110 comprise an amplitude DOE 112, which is a covert security feature of security documents embodying the invention.

As will be appreciated by persons skilled in the art, the process of ablating the layers 102, 103 by the use of patterned laser radiation via the substrate 100 may be a convenient means to form the amplitude DOE, however other methods are possible. For example, a scribe laser may be used, either via the substrate 100, or directly onto the layers 102, 103, in order to ablate apertures.

In another alternative, an etching process may be used, either via mechanical or chemical means.

Subsequently, a layer of liquid crystal material 114, such as a liquid crystal polymer (LCP) is applied to the substrate 100. According to the illustrated embodiment, the liquid crystal material 114 is preferably initially in a liquid crystalline state, such that the material is able to flow and cover the grooves formed in the grating layer 103. In doing so, liquid crystal molecules align substantially along the longitudinal axes of the grooves. The liquid crystal material 114 may include a solvent for assisting in applying the liquid crystal molecules to the grooves. The liquid crystal material 114 may be applied to the grooves using a printing technique, for example flexo-graphic printing or gravure printing. Preferably, the technique used to apply the liquid crystal material 114 has minimal impact on the alignment of the liquid crystal molecules, such that the molecules are free to align with the grooves.

Following application and alignment, the liquid crystal material 114 is cured. In some embodiments, curing is achieved by exposing the liquid crystal material 114 to ultraviolet (UV) light from a suitable light source. After a sufficient curing time, the liquid crystal material 114 is cured such that the liquid crystal molecules are restrained from changing orientation. As a result, light transmitted through the liquid crystal material 114, where aligned in the grooves of the grating layer 103, is polarised by the liquid crystal molecule alignment.

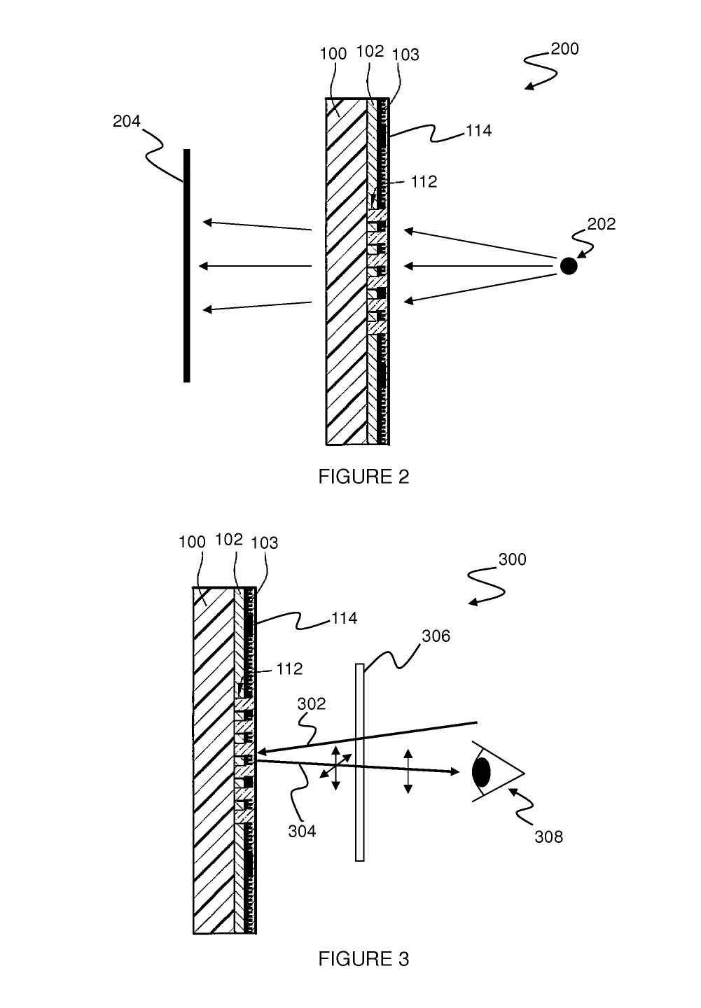

Turning now to FIG. 2, there is shown schematically an exemplary arrangement 200 for viewing the transmissive amplitude DOE feature of the security document. A point light source 202 generates optical radiation which passes through the DOE 112. The light transmitted through the DOE 112 interferes on the opposite side of the security document, causing an image to be formed in a reconstruction plane 204. The image may be projected onto a screen located in the reconstruction plane 204, may be detected using an electronic sensor, such as a CCD array, or may be viewed directly with the naked eye. For example, an observer looking through the DOE 112 at a light source which is sufficiently distant and/or small in size, to approximate a point source, will be able to see an image if the reconstruction plane 204 approximately coincides with the observer's retina.

FIG. 3 shows schematically an arrangement 300 for viewing a covert image within a security device embodying the invention. Ambient light 302 is incident upon the security document, and is reflected from the grating layer 103. Where the light strikes portions of the grating layer 103 in which arrangements of grooves are formed, the reflected light 304 is polarised according to the alignment of the cured liquid crystal molecules. Accordingly, if a polariser 306 is placed in the path of the reflected light, components of the reflected light having orthogonal polarisation to the orientation of the polariser 306 will be blocked. By reorienting (e.g. rotating) the polariser 306, corresponding light and dark patterns will be visible at a viewing location 308 from which light passing through the polariser 306 is observed.

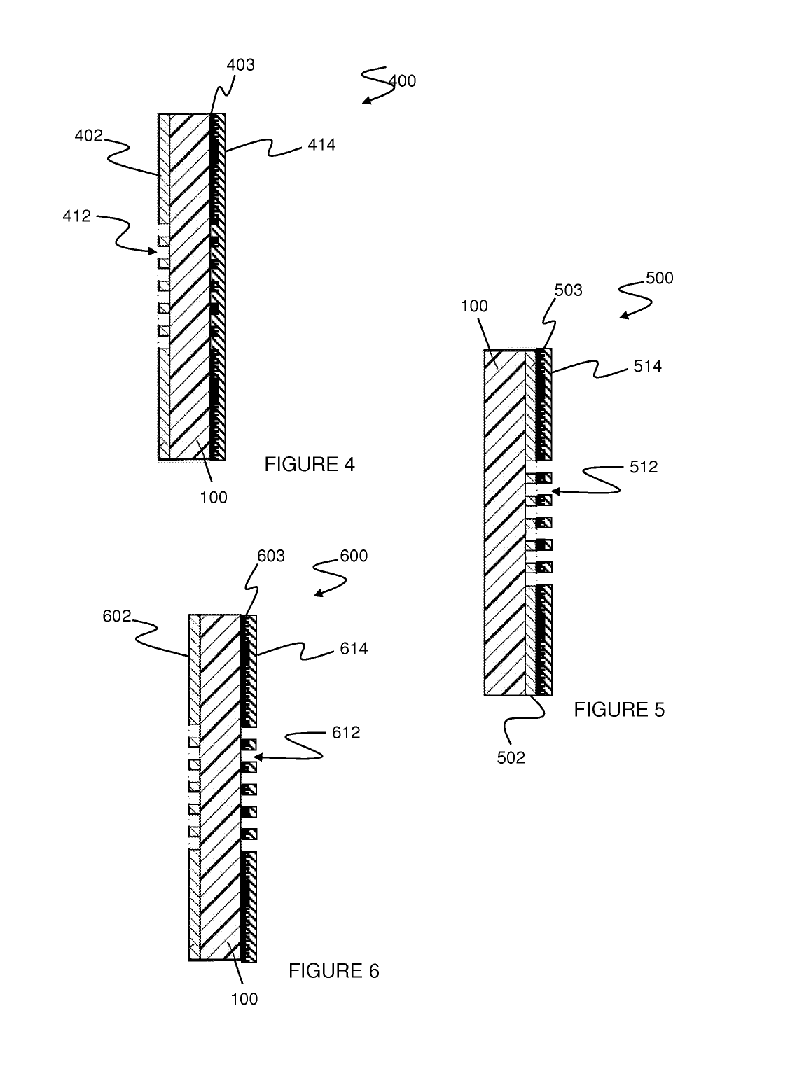

FIGS. 4, 5 and 6 illustrate three further embodiments of security documents and security devices having covert transmissive and covert reflective image features according to the present invention.

FIG. 4 illustrates a security document 400 in which an opacifying layer 402 has been formed on a first side of the substrate 100, whereas the grating layer 403 has been formed on the opposing side of the substrate 100. An amplitude DOE 412 has been formed by ablating apertures through the opacifying layer 402 and the grating layer 403, for example by directing light from a scribe laser or a patterned laser beam onto the surface from one or both sides of the substrate 100.

FIG. 5 illustrates a further embodiment 500 similar to the embodiment shown in FIG. 1, in which an opacifying layer 502, a grating layer 503 and a liquid crystal material layer 514 have been applied to a single surface of a substrate 100. In the embodiment 500, ablation of the coating layers has been performed following the application and curing of the liquid crystal layer 514, resulting in the formation of an amplitude DOE 512 comprising apertures passing through all three layers.

FIG. 6 illustrates a further embodiment 600 in which, as in the embodiment 400, an opacifying layer 602 has been disposed on a first surface of the substrate 100, and grating and liquid crystal layers 603, 614 have been disposed on the opposing side. Subsequently, an amplitude DOE 612 has been formed by ablating apertures through all three layers.

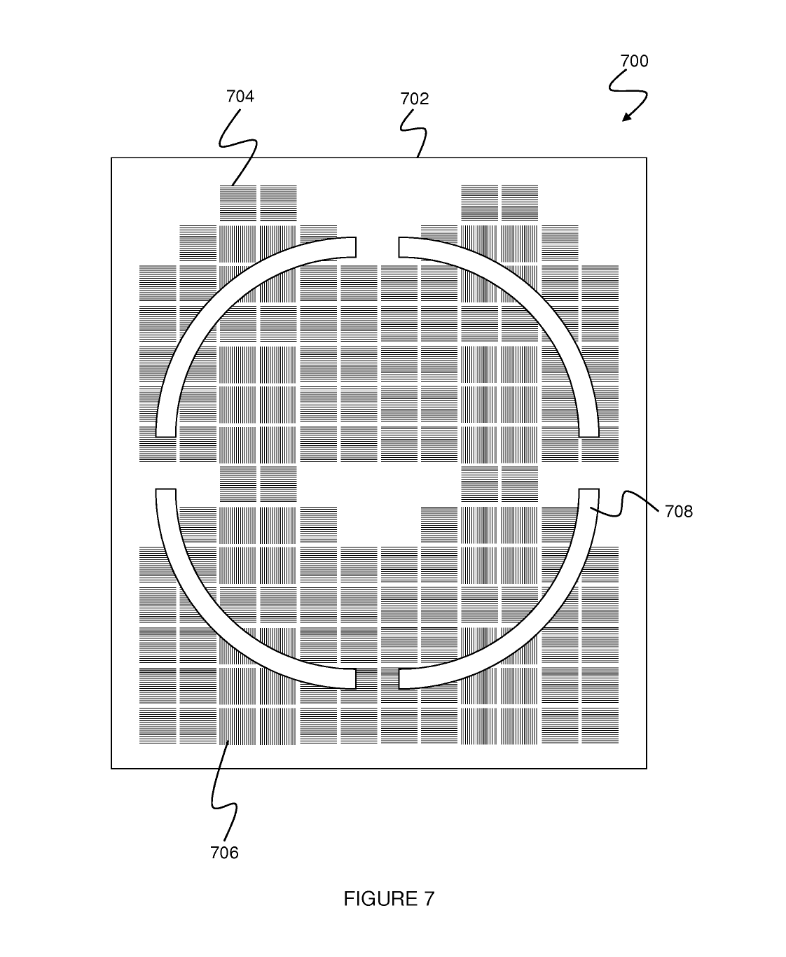

FIG. 7 is a schematic illustration 700 showing combined covert transmissive and reflective images in a security device, according to an embodiment of the invention. The device 700 comprises a substrate 702, upon which an opacifying layer has been deposited, followed by a grating layer comprising a number of groove arrangements having different orientations, such as horizontal orientation 704 and vertical orientation 706. Apertures 708 have been ablated in the opaque layers, and a liquid crystal layer has been deposited and cured.

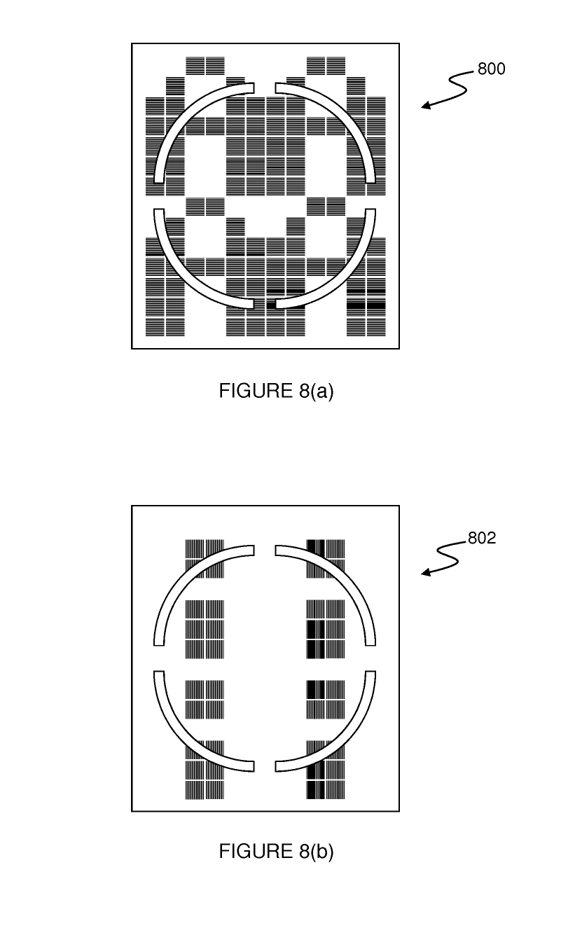

FIG. 8(a) illustrates the covert image of FIG. 7 as viewed through a polariser having a first orientation, i.e. a polariser with a vertical orientation causing regions bearing horizontally oriented groove arrangements 704 to appear as dark patches within the image 800. FIG. 8(b) illustrates the alternative image 802 which becomes visible if the polariser is rotated through 90 degrees.

While the greatest contrast between alternative covert images is achieved by using arrangements of grooves oriented perpendicularly, it will be appreciated that additional orientations may be employed, such that a range of different visual images may be observed while rotating a polariser through which the security device 700 is viewed. Alternatively, security devices may be formed in which the grooves have only a single orientation, such that only a single covert image is visible through a suitably oriented polariser.

While a number of embodiments of the invention have been described, these are not intended to be limiting of the scope of the invention. A number of variations and modifications will be apparent to persons skilled in the relevant art, such as forming grooves having different orientations and patterns within the grating layer. Furthermore, different methods of forming apertures within opaque layers disposed on the surface of a transparent substrate will also be known to persons skilled in the art. Additionally, the cross-sectional shape of the grooves may take on a variety of forms, so long as they are suitable to assist alignment of liquid crystal molecules. Accordingly, the scope of the invention should be understood to be as defined in the claims appended hereto.

1-15. (canceled)

16. A security device comprising:
a transparent substrate;
an opacifying layer;
a reflective grating layer comprising one or more arrangements of grooves; and
a liquid crystal material layer disposed over at least a portion of the grating layer,
wherein the arrangement of grooves have a groove spacing such that liquid crystal molecules within the liquid crystal material layer are substantially aligned so as to polarise optical radiation passing therethrough, and
wherein the security device further includes apertures formed in the opacifying layer and the grating layer, the apertures comprising a transmissive diffractive optical element (DOE).

17. A method of manufacturing a security device comprising:
providing a transparent substrate;
applying an opacifying layer to a surface of the transparent substrate to form an opacified substrate;
forming a reflective grating layer on or in a surface of the opacified substrate;
applying a liquid crystal material layer to the surface of the opacified substrate on which the grating layer is formed, and curing the liquid crystal material layer; and
forming apertures in the opacifying layer and the grating layer to form a transmissive diffractive optical element (DOE) in the security device, wherein the reflective grating layer comprises one or more arrangements of grooves having a groove spacing such that liquid crystal molecules within the liquid crystal material layer are substantially aligned so as to polarise optical radiation passing therethrough.

18. A security device according to claim 16, wherein the one or more arrangements of grooves comprise regions of grooves having a first orientation configured such that a first image is visible when the security device is viewed through a polariser having a corresponding first orientation.

19. A security device according to claim 16, wherein the one or more arrangements of grooves further comprise regions of grooves having a second orientation configured such that a second image is visible when the security device is viewed through a polariser having a corresponding second orientation.

20. A security device according to claim 16, wherein the arrangements of grooves in the grating layer comprise gratings having a zero-order characteristic within a predetermined viewing range of optical frequencies.

21. A security device according to claim 16, wherein the grating layer is formed in a surface of the opacifying layer.

22. A security device according to claim 16, wherein the grating layer is formed in an embossable material layer of the security device.

23. A security device according to claim 22, wherein the embossable material layer is disposed on a surface of the opacifying layer.

24. A security device according to claim 22, wherein the opacifying layer is disposed on a first surface of the substrate and the embossable material layer is disposed on a second surface of the substrate, opposite to the first surface.

25. A security device according to claim 16, wherein the apertures are further formed in the liquid crystal material layer, aligned with the apertures in the opacifying layer and the grating layer.

26. A security device according to claim 19, wherein the grooves in the grating layer have a period of between 100 nm and 1 μm.

27. A security device according to claim 26, wherein the grooves in the grating layer have a period of between 100 nm and 300 nm.

28. A security document comprising a security device comprising:
a transparent substrate;
an opacifying layer;
a reflective grating layer comprising one or more arrangements of grooves; and
a liquid crystal material layer disposed over at least a portion of the grating layer,
wherein the arrangement of grooves have a groove spacing such that liquid crystal molecules within the liquid crystal material layer are substantially aligned so as to polarise optical radiation passing therethrough, and
wherein the security device further includes apertures formed in the opacifying layer and the grating layer, the apertures comprising a transmissive diffractive optical element (DOE).

29. A method according to claim 17, wherein the one or more arrangements of grooves comprise regions of grooves having a first orientation configured such that a first image is visible when the security device is viewed through a polariser having a corresponding first orientation.

30. A method according to claim 29, wherein the one or more arrangements of grooves further comprise regions of grooves having a second orientation configured such that a second image is visible when the security device is viewed through a polariser having a corresponding second orientation.

31. A method according to claim 17, wherein the arrangements of grooves in the grating layer comprise gratings having a zero-order characteristic within a predetermined viewing range of optical frequencies.

32. A method according to claim 17, wherein the grating layer is formed in a surface of the opacifying layer.

33. A method according to claim 17, wherein the grating layer is formed in an embossable material layer of the security device.

34. A method according to claim 33, wherein the embossable material layer is disposed on a surface of the opacifying layer.

35. A method according to claim 33, wherein the opacifying layer is disposed on a first surface of the substrate and the embossable material layer is disposed on a second surface of the substrate, opposite to the first surface.

36. A method according to claim 17, wherein the apertures are further formed in the liquid crystal material layer, aligned with the apertures in the opacifying layer and the grating layer.

37. A method according to claim 30, wherein the grooves in the grating layer have a period of between 100 nm and 1 μm.

38. A method according to claim 37, wherein the grooves in the grating layer have a period of between 100 nm and 300 nm.

39. A method according to claim 17, wherein the apertures are formed by ablation.

40. A method according to claim 39, wherein the apertures are formed by laser ablation.

41. A security document including a security device manufactured according to the following:
providing a transparent substrate;
applying an opacifying layer to a surface of the transparent substrate to form an opacified substrate;
forming a reflective grating layer on or in a surface of the opacified substrate;
applying a liquid crystal material layer to the surface of the opacified substrate on which the grating layer is formed, and curing the liquid crystal material layer; and
forming apertures in the opacifying layer and the grating layer to form a transmissive diffractive optical element (DOE) in the security device, wherein the reflective grating layer comprises one or more arrangements of grooves having a groove spacing such that liquid crystal molecules within the liquid crystal material layer are substantially aligned so as to polarise optical radiation passing therethrough.
